(19) United States
(12) Patent Application Publication
(10) Pub. No.: US 2024/0317072 A1
(43) Pub. Date: Sep. 26, 2024

(54) ELECTRICAL ASSISTANCE FOR A ROLLER SKATING DEVICE

(71) Applicant: Mohamed SOLIMAN, Saint Denis (FR)

(72) Inventor: Mohamed SOLIMAN, Saint Denis (FR)

(21) Appl. No.: 18/578,320

(22) PCT Filed: Jul. 13, 2022
(86) PCT No.: PCT/EP2022/069674

§ 371 Date: Jan. 11, 2024

(30) Foreign Application Priority Data
Jul. 13, 2021 (FR) FR2107612

(51) Int. Cl. B60L 15/20; A63C 17/12; A63C 17/14; H02P 6/15

(52) U.S. Cl. CPC B60L 15/2018; A63C 17/12; A63C 17/14; H02P 6/157; B60L 2200/24

(57) ABSTRACT

A wheeled sliding device with electric assistance (400), comprising at least two wheels (104), which also comprises:
a means (13, 14) for measuring a value of a physical quantity representative of a movement of the wheeled device;
a means (15) for detecting a propulsion event, as a function of a value of a physical quantity representative of the movement measured, this event corresponding to a foot propulsion action of the device by a user; and
a motor (105) configured to drive in rotation at least one said wheel during a predefined period of time referred to as “pulse duration” after a foot propulsion event has been detected.

### TECHNICAL FIELD OF THE INVENTION

The present invention relates to an electrically assisted wheeled sliding device, a module for a wheeled sliding device with electric assistance, and a method of electric assistance for a wheeled sliding device. It applies, in particular, to wheeled sliding devices such as skateboards, inline skates, roller skates and scooters.

### STATE OF THE ART

There are currently several types of electrically-propelled devices. In particular, there has been an increase in scooters, skateboards, for example “longboard” or “longskate” type with electrical propulsion. However, a user on an electrically-propelled wheeled device loses all sensation of the sport initially practised since he operates a controller allowing him to move forward without having to make the slightest physical effort for propulsion.

Electrically assisted bikes are also known, which make it possible to help a user maintain a target speed by the action of an electric motor on a wheel in addition to the efforts provided by the user. However, the electrically assisted bikes generally take into account the rotational speed of a crankset and/or the pressure exerted on the pedals to deduce the energy to be supplied by the motor. Moreover, the devices implemented on electrically assisted bikes are bulky in view of the weight of the bike to be moved and the size of the wheels requiring the application of a high torque.

Hoverboards use a gyrometer, electrical skateboards a remote control (sometimes a pressure sensor), and scooters a trigger or a throttle on the handlebar to determine the amount of electric energy to be supplied so as to reach a certain speed.

Patent application US 2019/184 265 is known, which discloses electrically-assisted inline skates using an acceleration sensor to detect the user's movement.

Patent application US 2013/282 216 is also known, which discloses electrically-assisted inline skates using load sensors or the detection of movement for determining that a user is making a propulsion movement.

These two methods are demanding in terms of calculation since integrals and various filters are necessary to process the signal. It is also costly and cumbersome since one or more dedicated sensors have to be added, for example an accelerometer or an inertial unit, load sensors or sensors on the user's feet and wrists.

### PRESENTATION OF THE INVENTION

The present invention aims to remedy all or part of these drawbacks.

To this end, the present invention envisions, according to a first aspect, a module for a wheeled sliding device with electric assistance comprising at least two wheels, the module comprising:
a means for measuring a voltage of at least one phase of a three-phase electric motor representative of a movement of the wheeled device;
the 3-phase electric motor configured to drive in rotation at least one said wheel during a predefined period of time referred to as “pulse duration” after a foot propulsion event has been detected; and
a means for detecting a propulsion event, as a function of a voltage value of at least one phase of the 3-phase electric motor and at least one predefined voltage limit, this event corresponding to a foot propulsion of the device by a user.

Thanks to these provisions, the user retains the sensations of pushing with the foot that is associated with doing a sliding sport, for example inline skating, roller skating, skateboarding or scootering, while having occasional electric assistance at the time of foot pushes made to go up slopes or to travel a greater distance using little effort.

In addition, it is not necessary to add costly sensors because 3-phase electric motors have a means for controlling speed and therefore a means for measuring at least one voltage. The module can dispense with an accelerometer and solely process the voltages between the phases of the generator to determine whether an acceleration is or is not required. In some embodiments the detection means compares each back electromotive force between each phase of the motor and the ground to at least one predefined voltage limit.

Thanks to these provisions, since two phases of the motor can be zero at the same time, it is possible, at each instant, to identify a propulsion event corresponding to a back electromotive force in at least one of the motor phases that is greater than a predefined voltage limit.

In some embodiments the detection means also comprises a means for detecting a pace of the user according to the result of a comparison between a voltage value of at least one phase of the 3-phase motor and several predefined voltage limits, each predefined voltage limit being representative of a pace of the user.

Thanks to these provisions, it is possible to determine at what pace, in other words at what speed, a user is moving based on a single voltage measurement.

In some embodiments, the detection means also comprises a means for controlling a cyclic ratio of an electric signal supplying the 3-phase electric motor with electrical energy as a function of the pace determined.

Thanks to these provisions, it is possible to adjust the power supplied to the motor to assist the user when a propulsion event is detected.

In some embodiments, the module that is the subject of the present invention also comprises a means for controlling a pulse duration as a function of the pace determined.

Thanks to these provisions, the pulse duration can be adjusted to the pace of the user. This is because the user going fast puts his foot on the ground for a shorter time during a propulsion event, and the propulsion time must therefore be adjusted accordingly.

In some embodiments, the detection means is configured to detect a braking event as a function of a value of the derivative of the voltage of at least one phase of the 3-phase motor and of at least one predefined negative limit value, called the “predefined derivative limit”.

In some embodiments, a means for activating a motor brake when the value of the derivative of the voltage of at least one phase of the 3-phase motor is less than a predefined derivative limit.

Thanks to these provisions, a motor brake can be activated to assist the user in his braking effort.

In some embodiments, the module that is the subject of the present invention comprises:
a second means for measuring a value of a physical quantity representative of a movement, comprising a means for measuring an angular change configured to measure a value of a physical quantity representative of an inclination of the device, and wherein
the detection means comprises a determination means for identifying an increase or decrease in the inclination measured; and
this device comprises a means for inhibiting the motor as a function of the value of inclination measured.

Thanks to these provisions, the electric assistance is deactivated when the user is going down a slope, which avoids causing an unsafe excessive speed for the user.

In some embodiments, the device is an inline skate or roller skate, which also comprises:
a means for calculating at least one angular difference;
a means for detecting a braking event, representative of braking by the user, comprising a means for comparing the angular difference with a predefined angular limit value, the braking event being detected when the angular change is greater than a predefined angular limit value.

Thanks to these provisions, the actions of the motor are adjusted to the movements of the user.

In some embodiments, a drive speed of the motor is reduced when a braking event is detected.

Thanks to these provisions, the motor provides the user with assistance in braking.

In some embodiments, the device that is the subject of the present invention comprises an autonomous electrical power source configured to power the motor, the motor comprising at least one generator configured to generate electrical energy, the autonomous electrical power source being charged by the electrical energy produced.

Thanks to these provisions, the power source is charged when going down a slope. In the case of inline skates and roller skates, the electrical power source positioned on a skate or inline skate fitted on one foot of the user can be charged when the roller skate or inline skate fitted on the user's other foot is in contact with the ground.

In some embodiments, the pulse duration is less than two seconds and preferably less than one second.

Thanks to these provisions, the electric assistance gives help in moving, but not a continuous propulsion.

According to a second aspect, the present invention envisions a wheeled sliding device with electric assistance, comprising at least two wheels and a module that is the subject of the present invention.

As the particular aims, advantages and features of the device that is the subject of the present invention are similar to those of the module that is the subject of the present invention, they are not repeated here.

In some embodiments, the present invention envisions a pair of devices that are the subject of the present invention, wherein each device is an inline skate or a roller skate and a propulsion event being detected when the voltage measured is greater than the predefined voltage limit on a single one of the pair of devices.

Thanks to these provisions, confusion is avoided between a propulsion and maintaining one's feet on the ground when going down a slope, for example.

In some embodiments, each device comprises a means for communicating with the other device, configured to communicate the voltage measured by the device comprising the communication means and/or when the voltage measured by the device comprising the communication means is greater than the predefined voltage limit.

Thanks to these provisions, a single one of the devices can comprise the comparison means or it is possible to communicate only when the voltage measured is greater than the predefined voltage limit in order to reduce energy use.

In some embodiments, at least one detection means of a device is configured to detect a downslope or freewheel event as a function, for each device of the pair, of:
a voltage value of at least one phase of the 3-phase electric motor and at least one predefined voltage limit; and
a sign of the derivative of the voltage of this phase of the 3-phase motor.

Thanks to these provisions, always based on a single voltage measurement, it is possible to determine whether the user is going down a slope or freewheeling, without needing an additional sensor.

In some embodiments, the detection means 15 is configured to detect a freewheel event when the value of the derivative of the voltage of this phase is less than the “predefined derivative limit”.

Thanks to these provisions, it is possible to determine whether the user is braking or freewheeling, without needing an additional sensor.

According to a third aspect, the present invention envisions a method of electric assistance for a wheeled sliding device comprising at least two wheels, the method comprising:
a step of measuring a voltage of at least one phase of a 3-phase electric motor representative of a movement of the wheeled device;
a step of motorisation configured to drive in rotation at least one said wheel during a predefined period of time referred to as “pulse duration” after a foot propulsion event is detected; and
a step of detecting a propulsion event, as a function of a voltage value of at least one phase of the 3-phase electric motor and at least one predefined voltage limit, this event corresponding to a foot propulsion of the device by a user.

As the particular aims, advantages and features of the method that is the subject of the present invention are similar to those of the device that is the subject of the present invention, they are not repeated here.

### BRIEF DESCRIPTION OF THE FIGURES

Other advantages, aims and particular features of the invention will become apparent from the non-limiting description that follows of at least one particular embodiment of the device, module and method that are the subjects of the present invention, with reference to drawings included in an appendix, wherein:

FIG. 1 represents, schematically, a first particular embodiment of a device that is the subject of the present invention;

FIG. 2 represents, schematically, a curve representative of the acceleration of the device that is the subject of the present invention along the axis of movement as a function of time;

FIG. 3 represents, schematically, a curve representative of the acceleration of an inline skate or roller skate that is the subject of the present invention along the lateral axis as a function of time;

FIG. 4 represents, schematically, a curve representative of the speed of the device that is the subject of the present invention compared to the speed of a device without electric assistance and the speed of an electrically-propelled device as a function of time;

FIG. 5 represents, schematically, the power supply mode of the motor as a function of the events detected;

FIG. 6 represents, schematically and in perspective, a first particular embodiment of a roller skate that is the subject of the present invention;

FIG. 7 represents, schematically and in perspective, a first particular embodiment of a skateboard that is the subject of the present invention;

FIG. 8 represents, schematically and in perspective, a first particular embodiment of a scooter that is the subject of the present invention;

FIG. 9 represents, schematically, a first particular embodiment of a pair of inline skates and a portable communicating terminal that is the subject of the present invention;

FIG. 10 represents, schematically, a curve representative of the voltage of the electric current produced between a phase of the motor and the ground as a function of time;

FIG. 11 represents, schematically and in the form of a logic diagram, a series of steps of a particular embodiment of a method that is the subject of the present invention; and

FIG. 12 represents, schematically, a second particular embodiment of a device that is the subject of the present invention.

### DESCRIPTION OF THE EMBODIMENTS

The present description is given in a non-limiting way, in which each characteristic of an embodiment can be combined with any other characteristic of any other embodiment in an advantageous way.

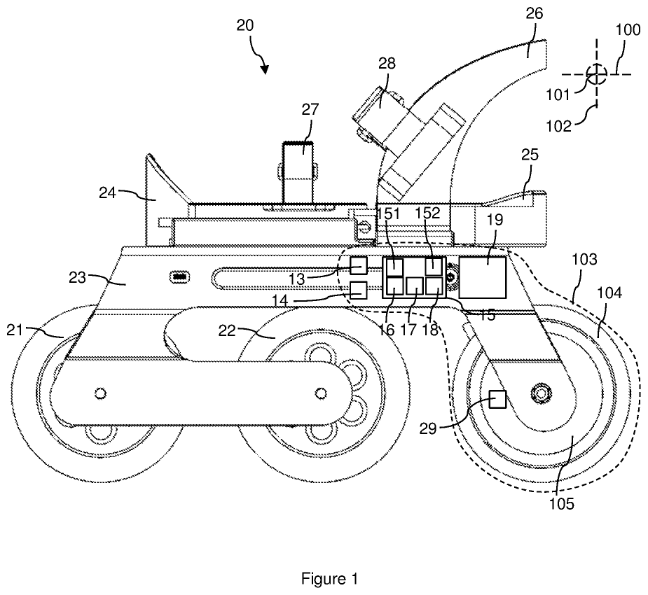

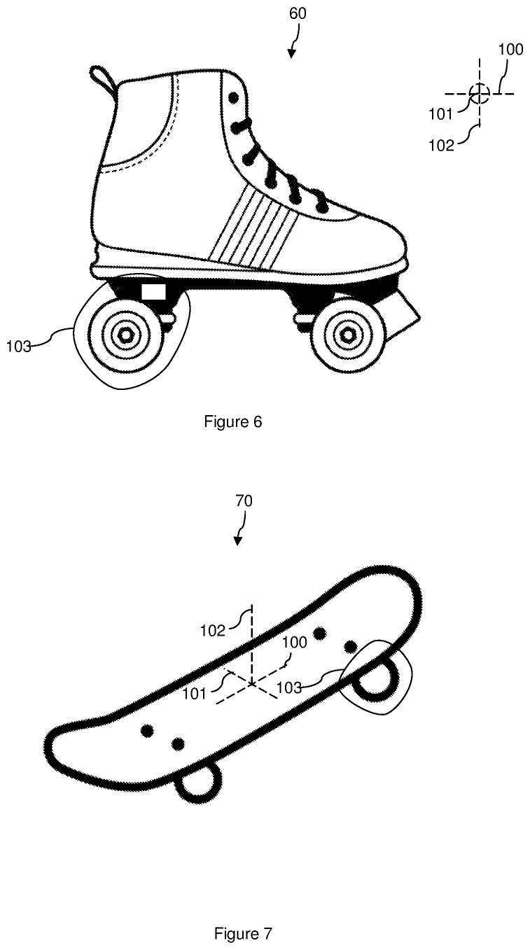

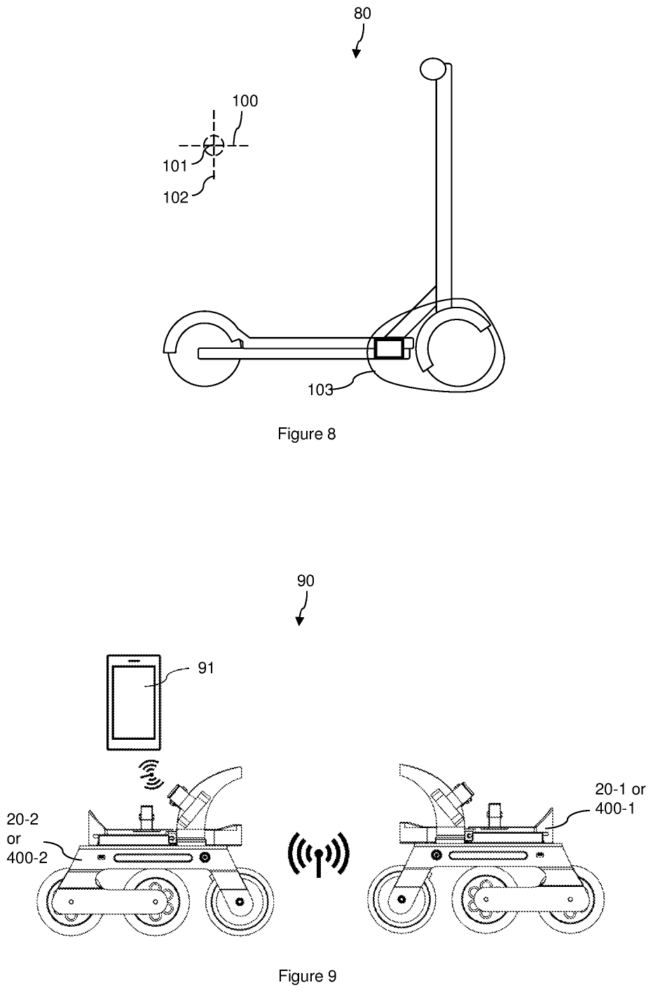

In the remainder of the description, the following terms have the following definitions:
“front” or “fore”: being located on the left in FIG. 1 and on the right in FIGS. 6 and 8;
“back” or “rear”: being located on the right in FIG. 1 and on the left in FIGS. 6 and 8;
“left”: being located in the foreground in FIG. 1 and in the background in FIGS. 6 and 8;
“right”: being located in the background in FIG. 1 and in the foreground in FIGS. 6 and 8;
“lateral” or “side”: being located on either the right or left.

These orientations correspond to the orientations in relation to a user positioned on the devices represented in FIGS. 1, 6 and 8, in position of use.

The term “foot propulsion” refers to a gesture made with the user's foot to make the device move in a given direction called the “axis of movement”. The foot propulsion in the case of a skateboard or a scooter is, for example, a foot bearing on the ground to push and move in the given direction, the other foot being on the scooter or skateboard.

In the case of inline skates or roller skates, the foot propulsion corresponds to a movement bearing on one inline skate or roller skate, forming an angle less than 90° with the axis of movement, and then on the other. The feet form a “V” in a way known to the person skilled in the art.

The methods for moving on inline skates by being propelled using a foot on the wheeled devices are known to the person skilled in the art. These methods use foot propulsions, i.e. by a foot pushing on the ground.

A coordinate space is defined comprising the axis of movement 100, an axis perpendicular to the axis of movement and parallel to the axis of rotation of the wheels 101, called the “lateral axis”, and an axis perpendicular to the axis of movement and the lateral axis, called the “vertical axis” 102. It is noted here that, regardless of the number and arrangement of wheels of a wheeled device, the axes of rotation of the wheels are parallel. Regardless of the type of device, the axes are the same. The reference space is therefore shown in FIGS. 1, 6, 7 and 8.

Note that a wheeled sliding device is a device equipped with wheels making it possible to do sliding sports. Wheeled sliding devices are scooters, skateboards, inline skates, roller skates. Bikes and motocross bikes (acronym “BMX”) are not considered sliding devices. Wheeled sliding devices have wheels with a diameter generally between 80 mm and 200 mm.

Note that the figures are not to scale.

FIG. 1, which is not to scale, shows a schematic view of an embodiment of the electrically assisted wheeled sliding device 20 that is the subject of the present invention.

The device 20 is an inline skate. The inline skate 20 comprises at least two wheels, 104, 21 and/or 22, with axes of rotation parallel and different. In the embodiment shown, the inline skate 20 comprises three wheels, 104, 21 and/or 22, whose axes of rotation are parallel and equidistant. The wheels are aligned in a way known to the person skilled in the art along an axis parallel to the axis of movement. In some variants (not shown), the inline skate 20 comprises four wheels.

The inline skate 20 comprises a frame 23 to which the wheels, 104, 21 and/or 22, are fixed. The frame 23 also comprises a plate for receiving a shoe or the foot of a user, and means, 24, 25, 26, 27 and/or 28, for fastening a shoe or a foot of a user.

Preferably, the fastening means, 24, 25, 26, 27 and/or 28, comprise two parts 24 and 25, at least one of which is mobile in translation along the axis of movement 100 relative to the frame 23. The part 25 is called the “back part” because it is configured to be positioned in contact with the heel of a shoe or a foot, and the part 24 is called the “front part” because it is configured to be positioned at the location of the toes or end of the shoe containing the toes. These embodiments allow the inline skate to be adapted to all sizes of shoes and feet. For example, at least one part, 24 or 25, is fixed to the frame by means of a sliding link with an axis parallel to the axis of movement, whose embodiments are known to the person skilled in the art. Preferably, the back part 25 is mobile relative to the frame 23.

Preferably, the two parts, 24 and 25, of the fastening means are connected by a return spring (not shown) configured to bring the parts 24 and 25 closer together in the axis of the sliding link. The user can therefore position a shoe or a foot between the two parts and the spring brings each part 24 and 25 closer to enter into contact with, firstly, the heel and, secondly, the end of the toes or the part of the shoe containing the end of the toes.

Preferably, the front part 24 comprises a stop at the extremity farthest from the back part along the axis of the sliding link, and the back part 25 comprises a stop at the extremity farthest from the front part along the axis of the sliding link, the stops making it possible to ensure that the shoe and/or foot are held in place, like a vice, by the two parts, 24 and 25, of the fastening means.

In some embodiments, the front part 24 comprises a fastener 27 extending in the opposite direction to the wheels, configured to surround the shoe or foot of the user. The fastener 27 comprises, for example, a strap fixed on one side of the front part 24 being inserted into a latch attached on the other side of the front part 24 in a way known to the person skilled in the art.

In some embodiments, the back part 25 comprises a fastener 28 extending in the opposite direction to the wheels, configured to surround at least partially the heel of a user. The fastener 28 comprises, for example, a strap fixed on one side of the back part 25 being inserted into a latch attached on the other side of the back part 25 in a way known to the person skilled in the art.

Preferably, the back part 25 comprises a support 26 configured to receive the heel of the user. The fastener 28 is preferably positioned opposite to the support 26 to enclose the heel of the user. These embodiments make it possible to avoid injuries to the heel in the event of a fall, for example.

The inline skate 20 comprises an electric assistance module 103 which comprises:
a means, 13 or 14, for measuring a value of a physical quantity representative of a movement of the device 20 with wheels, 104, 21 and/or 22,
a 3-phase electric motor 105 configured to drive in rotation at least one said wheel 104 during a predefined period of time referred to as “pulse duration” after a foot propulsion event is detected; and
a means 15 for detecting a propulsion event, as a function of a voltage value of at least one phase of the 3-phase motor and at least one predefined voltage limit, this event corresponding to a foot propulsion of the device 20 by a user.

In some embodiments, the module 103 can be removed. In other terms, the module 103 can be sold separately from the device 20, 60, 70 and/or 80. The module 103 can be part of a kit also comprising an autonomous electrical power source 19, and a means for fastening the autonomous electrical power source 19 to the device, 20, 400, 60, 70, and/or 80.

Preferably, the module 103 is incorporated into a wheel 104.

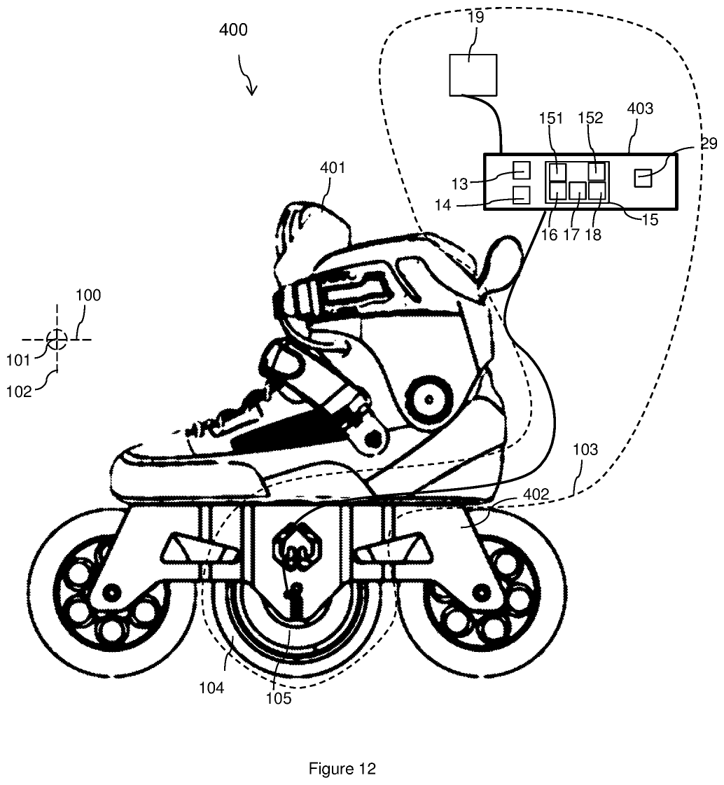

Preferably, as shown in FIG. 12, the motor 105 is incorporated into a wheel 104, and the other means 403 are connected to the motor 105 by a cable. The other means 403 are any means not incorporated with the motor or with the wheel 19 of the module 103 described above or below. These other means 403 and the autonomous electrical power source 19 can be incorporated into a bag. These embodiments make it possible to improve the compactness of the device and reduce the weight of each device because the autonomous poser source is remote. In these embodiments, the module 103 is sold as a kit comprising at least one wheel 104, an autonomous electrical power source 19 and said other means, in particular the measurement means 13 and the detection means 15, and one connection cable per wheel 104.

In some embodiments shown in FIG. 12, the device 400 is an inline skate and the wheel 104 comprising the motor 105 is fixed to a plate 402 configured to be compatible with any type of shoe 401 for an inline skate 400.

The motor 105 is activated during a predefined period of time referred to as “pulse duration” after a foot propulsion event is detected. Preferably, the pulse duration is less than two seconds and even more preferably less than one second. For example, the pulse duration is 500 ms. The pulse duration can be memorised in the memory.

In some embodiments, the pulse duration is adjusted following the application of a machine learning algorithm, or following an adjustment command issued by the module 103. In some variants, the adjustment command is received by the module 103 through a communication means.

Preferably, the 3-phase electric motor 105 is a brushless motor, otherwise called a “self-controlled permanent magnet synchronous machine”. Such a type of motor contains no rotating commutator, and therefore no brushes. On the contrary, a control means commutates the current in the stator windings. Preferably, the control means is incorporated into the motor in a way known to the person skilled in the art.

It is noted here that a 3-phase electric motor is an electric motor comprising three permanent magnets and therefore the power is supplied by a 3-phase electric current.

It is also noted that any motor produces an electromotive force (acronym “EMF”). The EMF refers to the voltage generated by a spinning motor. The measurement of this voltage in order to determine the rotational speed of a motor is called the back electromotive force (acronym “BEMF”), because the voltage tends to “push back” against the circuit that supplies power to the motor's windings.

An electric motor converts electrical energy into mechanical energy. Conversely, an electrical generator takes mechanical energy and converts it into electrical energy. Most motors can be generators simply by letting the motor run.

The inventors have noted that it is possible to use the measurement of the back electromotive force to control the movement of the motor, by exploiting the concept that a motor is also a generator. The voltage observed when the motor runs is directly proportional to its rotational speed and the physical properties of the motor. Thus, the rotational speed of the motor can be calculated without an optical encoder or other form of active feedback.

A motor 105 also operating as a generator can have two modes of operation:
Motor: consumes electrical energy by applying a voltage using pulse-width modulation;
Generator: generates electrical energy, which leads to a voltage between its phases and between each phase and the ground; this voltage is called the back electromotive force (acronym “BEMF”).

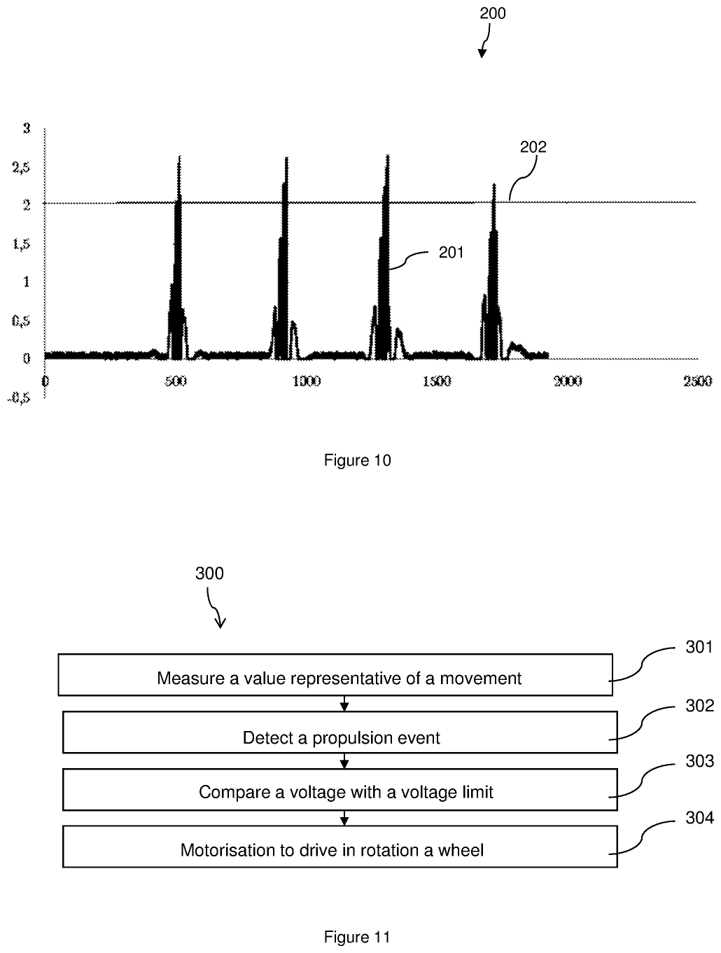

As shown in FIG. 10, when the user skates, a back electromotive force 201 is generated at the terminals of the generator 105. Before the user skates, the motor is in freewheeling mode and is not controlled to run. Once the user skates, the motor switches to generator mode and generates a voltage 201.

In the 3-phase electric motor 105, it is possible to measure the voltage at the terminals of each phase, firstly, and of a ground, secondly. Thus, for each of the phases, it is possible to detect a BEMF.

In some embodiments, the measurement means 13 measures at least one value representative of a voltage, the detection means 15 comprising a means 16 for comparing the voltage 201 measured with a predefined voltage limit 202, the propulsion event being detected when the voltage 201 measured is greater than at least one predefined voltage limit 202.

When the voltage 201 exceeds a predefined voltage limit 202, the motor 105 is controlled to run at a predefined speed during a pulse duration. In some embodiments, the speed is proportional to the voltage applied to the terminals of the motor.

The motor must not run indefinitely, for it is the principle of electric assistance, not of electric propulsion. The 3-phase electric motor 105 is supplied with electrical energy only in the phases of effort, to support the user and help him reduce the effort required to accelerate. Thus, once the desired speed or pace has been reached there is no longer any need for the motor to operate in motor mode. The motor then switches to freewheeling mode at the end of the pulse duration.

Preferably, the voltage 201 compared to the predefined voltage limit 202 is the BEMF between each phase of the motor and the ground.

In the embodiments in which the motor 105 is a brushless motor, the BEMF is calculated between each phase of the motor and the ground. It is noted that a brushless motor comprises at least three phases. Because of the rotation of the motor 105, the voltages between each phase and the ground are not zero at the same time, this phenomenon being known as “zero crossing”. A potential difference between a phase and the ground passes from a positive value to a negative value and therefore through a zero value. Passage to the zero value is detected by the means for controlling the rotational speed on the electric motor and then processed to choose on which phase a voltage must be applied. Several phases can have a zero voltage at the same time. Using the voltage produced by each phase makes it possible to avoid detecting a propulsion event when no propulsion movement has been made, since each phase passes alternately to a zero value. In other terms, the position of the rotor of the motor can be determined, while this position changes constantly, the voltages between each phase and the ground passes alternately to the zero value.

FIG. 10 shows a length of time on the X-axis, and the voltage generated by the generator on the Y-axis.

It can be seen that a voltage of more than two volts allows an acceleration to be identified. In FIG. 10, the predefined voltage limit 202 is equal to two volts. In FIG. 10, four propulsion events are detected.

In some embodiments, the device comprises a pair of devices, where each device is an inline skate 20 or a roller skate 60 and a propulsion event being detected when the voltage 201 measured is greater than the predefined voltage limit 202 on a single one of the pair of devices.

The more the user skates, the faster he will make the wheel 104, and therefore the 3-phase electric motor 105 that is inside, rotate. The motor generates a voltage proportional to its rotational speed. The inventors have discovered that it is therefore possible to accurately detect the acceleration/deceleration movements of the user with no additional sensor and by measuring the voltage between a motor phase and the ground, in particular by detecting anomalies.

Preferably, the means 15 for detecting a propulsion event compares a voltage value of at least one phase of the 3-phase motor with several predefined voltage limits, each predefined voltage limit being representative of a pace of the user.

For example, by setting several different predefined voltage limit values organised in increasing order, it is possible to define limits corresponding to paces such as starting, slow speed, short steps, big steps. Each time the BEMF exceeds a predefined voltage limit value higher than the previous predefined voltage limit exceeded, it is understood that the user wants to go even faster and a command is sent to the motor to operate accordingly.

The propulsion is associated with the power delivered by the motor, which is directly proportional to the electrical power supplied to the 3-phase electric motor 105.

Regardless of the physical quantity measured, when the motor 105 operates in motor mode, it consumes electrical energy by applying a voltage using pulse-width modulation (acronym “PWM”). Pulse width modulation, known to the person skilled in the art, makes it possible, by applying a rapid cycling of discrete states with chosen cyclic ratios, to obtain any intermediate value by only considering the average value of the signal.

Consequently, based on the cyclic ratio selected to perform the pulse width modulation it is possible to select the operating power of the motor, directly proportional to the average value of the voltage applied at its terminals.

The voltage applied between each phase and the ground has the same cyclic ratio applied alternatively.

Preferably, the cyclic ratio is equal to 0.5.

Note that the cyclic ratio and pulse duration can be adjusted by the user, for example by means of a communicating portable terminal 91 with the device, 20, 60, 70, and/or 80.

In some embodiments the cyclic ratio and pulse duration are determined by machine learning based on data stored in memory.

Preferably, the 3-phase electric motor 105 comprises a means for modulating the pulse width (not shown) configured to adjust the cyclic ratio of the signal representative of the electric current supplied to the 3-phase electric motor 105.

Preferably, each predefined voltage limit, for example 2V, 3V, 4V, 5V, is associated to a cyclic ratio value, for example 20%, 40%, 60%, 95%, so that the motor delivers the level of power corresponding to the above delivered pace of the user. Thus, if the power of the motor remains unchanged throughout use, the motor may either slow the user down above a certain speed, since the motor operates slower than a wheel propelled by the user, or, on the contrary, abruptly propel him when starting.

In other terms, the detection means 15 comprises:
a means 152 for detecting a pace of the user according to the result of a comparison between a voltage value of at least one phase of the 3-phase motor 105 and several predefined voltage limits, each predefined voltage limit being representative of a pace of the user;
a means 151 for controlling a cyclic ratio of an electric signal supplying the 3-phase electric motor 105 with electrical energy as a function of the pace determined.

In some embodiments, the control means 151 is configured to control a pulse duration as a function of the pace determined.

Preferably, the higher the pace, i.e. the more the predefined voltage limit is exceeded by the voltage value of at least one phase of the 3-phase motor 105, the shorter the pulse duration. In other terms, the pulse duration is a decreasing function of the pace. This makes it possible, in particular, to avoid hampering the user's movements. The faster the user goes, the less time his foot spends on the ground for the foot propulsion. If the motor continues to operate while the user is no longer moving, he risks being hampered or even falling.

The inventors have also noted that the BEMF can be used to determine when to activate a motor brake. Consequently, the detection means 15 is configured to detect a braking event as a function of a value of the derivative of the voltage of at least one phase of the 3-phase motor and of at least one predefined negative limit value, called the “predefined derivative limit”.

The derivative of a voltage represents an increase or decrease of the BEMF. It is therefore possible to detect the abrupt reduction in at least one BEMF, for example a BEMF value going from 3V to 0V in less than 200 ms representative of a braking element. In other terms, when a value of the derivative of the voltage of at least one phase of the 3-phase motor is less than a predefined negative limit value, called the “predefined derivative limit”, a mechanical braking event is detected, and the motor switches to motor brake mode to support the user.

Preferably, the value of the derivative of the voltage 201 compared to the predefined voltage limit 202 is the value of the derivative of the BEMF between each phase of the motor and the ground.

It is noted here that to activate a motor brake, in the case of a 3-phase electric motor 105, the control means 151 is configured to power the motor so as to exert a torque in the opposite direction to the torque previously exerted.

In some embodiments in which two inline skates 20 or roller skates 60 are combined into a pair for the user's two feet, each element of the pair comprises a 3-phase electric motor 105 that generates one BEMF per phase.

Preferably, the inline skates 20 or roller skates 60 of a pair each comprise a communication means and are configured to communicate using the communication means as described below.

When the two devices, 20 or 60, of a pair communicate, the pace and braking of the skater can be detected, but it is also possible to determine whether the user is at rest, freewheeling or going down a slope.

The skating movement of a user is reciprocating, i.e. a BEMF 201 of a foot that skates is greater than a predefined voltage limit 202 whereas each BEMF of the other foot that is not skating remains less than each predefined voltage limit 202.

If the user decides to cease to skate, but continues with the shoes positioned on the ground, a BEMF is therefore generated on each shoe. The BEMF can become greater than the predefined voltage limit 202, without a propulsion movement being made by the user. Thus, if each of the devices of the pair generates a non-zero BEMF, the motor must not be put into operation, and must remain in generator mode.

Preferably, each device comprises a means for communicating with the other device, configured to communicate when the voltage measured of the device comprising the communication means and/or when the voltage measured is greater than the predefined voltage limit.

When the voltage 201 measured is greater than the predefined voltage limit 202 on both devices of the pair, the fact that the user is going down a slope, or does not want to be propelled, is detected and each motor 105 switches to generator mode, in other words to “freewheeling mode”. It is thus possible to detect that a user is going down a slope, and dispense with a gyroscope or any other means for determining an angular change. However, the gyroscope can enable greater accuracy, especially in detecting a rise by the user.

When, at the same time, a BEMF of each foot is greater than at least one predefined voltage limit, this means that:
either the user is going down a slope, and he is accelerating continuously due to gravity not because he wants to. The electric assistance is therefore deactivated, and the motor thus switches to generator mode to recharge the batteries;
or the user is freewheeling and has ceased to skate since he has reached the wished—for pace. The motor switches to freewheeling mode.

When the user is going down a slope, the derivative of the voltage corresponding to the BEMF that is greater than the predefined voltage limit is positive. When the user is freewheeling, the derivative of the voltage corresponding to the BEMF that is greater than the predefined voltage limit is negative.

The detection means 15 of a device, 20 or 60, of a pair is therefore configured to detect a downslope or freewheel event as a function, for each device of the pair, of:
a voltage value of at least one phase of the 3-phase electric motor and at least one predefined voltage limit; and
a sign of the derivative of the voltage of this phase of the 3-phase motor.

Preferably, to distinguish between freewheel events, on the one hand, and a braking event, on the other hand, the detection means 15. The detection means 15 is configured to detect a freewheel event when the value of the derivative of the voltage of this phase is less than the value of the “predefined derivative limit”.

The motor 105 can comprise a generator configured to generate electrical energy. For example, the rotation of the wheel 104 creates a magnetic field at the location of the magnets of the motor 105 when the motor is in freewheel mode, the magnetic field created is then converted into electrical energy.

This is especially advantageous in the case of inline skates and roller skates since, once the propulsion has been made with one foot, the other foot is placed on the ground, the wheel of the first foot being left in freewheeling mode, a portion of the energy used for the propulsion can therefore be recovered.

Preferably, once the pulse duration has ended, the motor 105 is in freewheeling mode, i.e. it is not supplied with electrical energy.

Preferably, the motor 105 comprises a proportional-integral-derivative (acronym “PID”) regulator in order to ensure that, whatever the disturbances, the output speed of the motor 105 on output, in other words the speed of the wheel 104, is always the same.

In some embodiments, the module 103 comprises an autonomous electrical power source 19 configured to power the motor 105. In the embodiments in which the motor 105 comprises a generator, the autonomous electrical power source 19 is charged by the electrical energy produced.

The autonomous electrical power source 19 is, for example, a battery.

In some embodiments, the autonomous electrical power source 19 comprises a means for connecting to an electrical network for charging the autonomous electrical power source 19.

In some embodiments compatible with the embodiments based on measuring one or more voltages at the terminals of the motor, the measurement means 13 is an accelerometer configured to detect an acceleration of the device on which the module 103 is fixed—the inline skate 20 with regard to FIG. 1, the roller skate 60 with regard to FIG. 6, the skateboard 70 with regard to FIG. 7 and the scooter 80 with regard to FIG. 8—along at least the axis of movement 100, and possible the lateral axis 101 and the vertical axis 102.

An acceleration along the axis of movement 100 represents a movement by the user for moving using the device, 20, 60, 70 and/or 80. An acceleration along the lateral axis 101 can represent a turn or a direction chosen by the user, or else a fall by the user in the event of a sudden acceleration. An acceleration along the vertical axis 102 represents, for example, the device, 20, 60, 70 and/or 80, going down a slope; in a similar way, a drop in acceleration along the vertical axis 102 represents, for example, the device going up a slope. A sudden acceleration along the vertical axis 102 can represent a fall.

In some embodiments, the module 103 comprises a means 14 for measuring an angular change, such as a gyroscope or an inertial unit, configured to measure a value of a physical quantity representative of an inclination of the device 20, 60, 70, and/or 80. Preferably, the means for measuring an angular change is configured to form redundancy and provide precision with respect to the measurement of the acceleration along the vertical axis 102.

Preferably, the values measured by the accelerometer 13 and the means 14 for measuring an angular change are recorded in a memory (not shown).

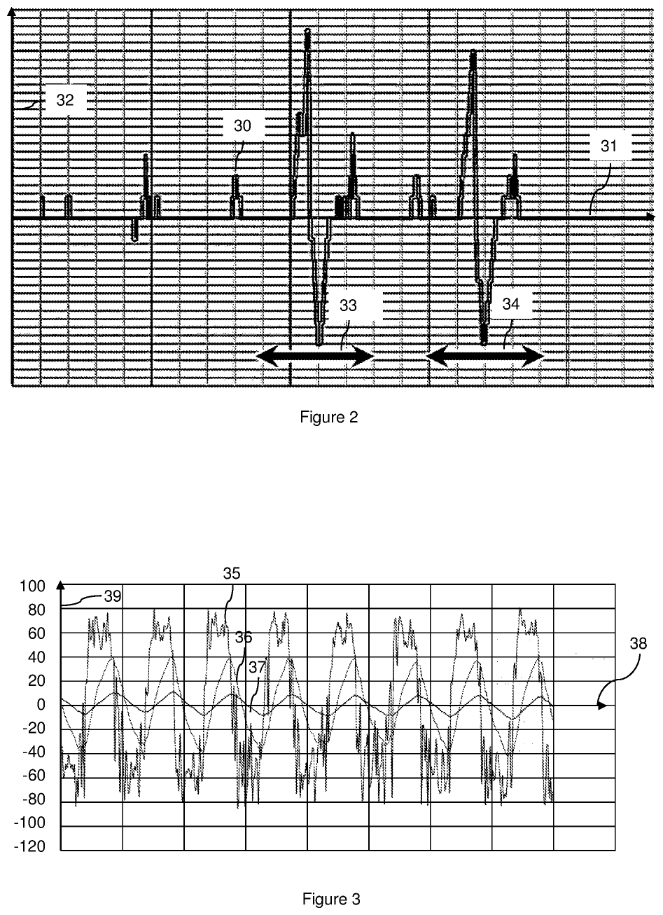

FIG. 2 shows an example of signal 30 representative of an acceleration along the axis of movement 100 by an accelerometer 13. The signal 30 is shown in a coordinate space where the X-axis 31 represents the time, and the Y-axis represents the instantaneous value of the acceleration measured by the accelerometer 13 along the axis of movement. Two events, 33 and 34, can be seen, corresponding to a foot propulsion, in which the acceleration increases abruptly.

The detection means 15, also referred to as the “detector”, is preferably a device configured to perform logical actions, such as a microprocessor executing a dedicated program.

The detection means 15 is configured to detect a propulsion event as a function of a value representative of the movement measured, this event corresponding to a foot propulsion of the device, 20, 60, 70, and/or 80, by a user.

The detection means 15 comprises a comparison means 16. The comparison means 16 can be connected to a memory (not shown) in which at least one predefined limit value is recorded. The comparison means 16, also referred to as the “comparator”, is configured to compare the acceleration along the axis of movement 100 with a predefined acceleration limit value. The detection means 15 detects the propulsion event when the acceleration along the axis of movement 100 is greater than the predefined acceleration limit value. For example, the predefined acceleration limit value is 5 m/s².

In some embodiments, the detection means 15 comprises a means for filtering at least one signal representative of the value measured. For example, a Kalman filter can be applied to each signal measured by the means for measuring an angular change, and a digital analogue filter can be applied to each signal representative of an acceleration coming from the accelerometer 13. In these embodiments, the value compared to the predefined acceleration limit value is the filtered value.

FIG. 3 shows a signal 35 representative of the inclination of the inline skate 20 along the axis of movement. The signal is shown in a coordinate space where the X-axis 38 represents the time, and the Y-axis 39 represents an angle. When a user is inline skating or roller skating, each foot makes a pendulum movement alternately. The signal 35 therefore has a periodic aspect.

In the graph shown in FIG. 3, two signals, 36 and 37, representing the application of filters to the signal 35, can also be seen. The signal 37 represents the application of a Kalman filter to the signal 35. The signal 36 represents the application of an exponential filter to the signal 35, which acts as a low-pass filter.

Obviously, the module 103 can comprise a means for measuring a value of an acceleration and/or a means for measuring a value of a voltage. The embodiments described above and below are not incompatible.

In some embodiments, the module 103 comprises at least one means 29 for measuring a value of a physical quantity representative of a rotational speed of at least one wheel 104.

In some embodiments, the means 29 for measuring a value of a physical quantity representative of a rotational speed of at least one wheel 104 is the accelerometer 13 and/or the means 13 for measuring a voltage, the value measured along the axis of movement makes it possible to calculate the speed along the axis of movement, and therefore the rotational speed of the wheel.

The motor 105 is configured to drive in rotation at least one wheel 104 during the pulse duration after a propulsion event has been detected at a speed greater than or equal to the rotational speed measured, and/or less than or equal to one hundred and fifty percent of the rotational speed measured.

In some embodiments, the rotational speed measured corresponds to the instantaneous speed at the time a propulsion event was detected.

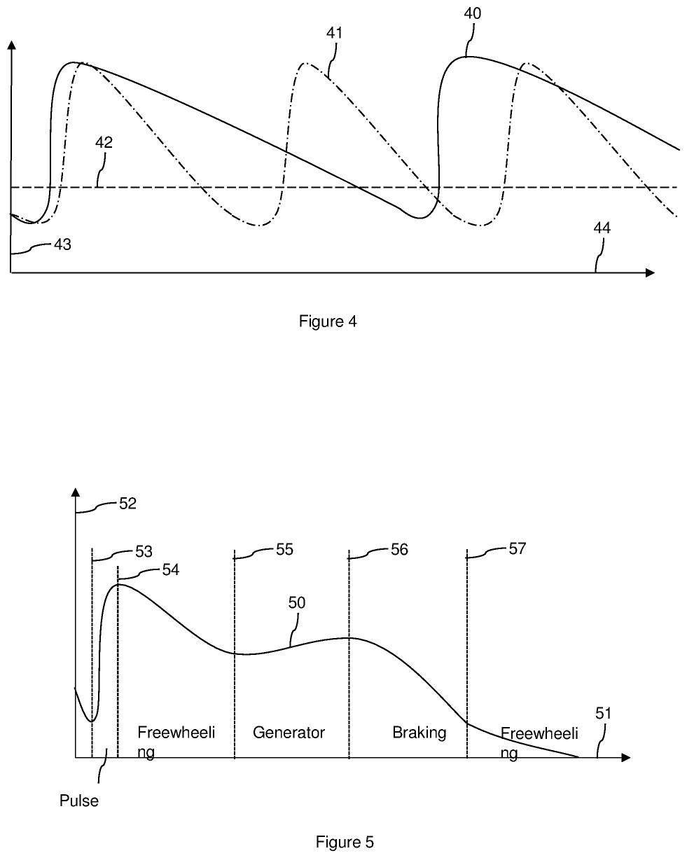

FIG. 4 shows a curve representative of the speed 40 of the device that is the subject of the present invention compared to the speed 41 of a device without electric assistance and the speed of an electrically-propelled device 42 as a function of time. The different curves are shown in a coordinate space where the X-axis represents the time, and the Y-axis represents the speed.

It is noted that the curve representative of the speed of an electrically-propelled device 42 is a constant curve that depends on the target value specified by the user. It is noted that the curves representative of the speed of a device without electric assistance 41 and with electric assistance 40 show oscillations, each local maximum following a foot propulsion event. The sensations of the user of an electric assistance module 103 are therefore the same sensations of pushing as with no electric assistance module 103, but with less effort, since the foot propulsion is required less frequently.

Preferably, the module 10 comprises a means 17 for inhibiting the motor 105 configured such that the wheel 104 operates in freewheeling mode, i.e. the motor produces neither braking nor acceleration.

In some embodiments, the detection means 15 comprises a determination means 18 for identifying an increase or decrease in the inclination measured. The determination means 18 can compare values of inclination measured, or else measure an angle in the plane comprising the axis of movement 100 and the vertical axis 102.

It is therefore possible to identify when going down a slope or up a slope.

In some embodiments, when a downslope movement is identified, the motor 105 operates in freewheeling mode. When the motor 105 is equipped with a generator, the motor 105 can store the energy generated by the rotation of the wheel 104 when going down a slope.

In other embodiments, the energy generated by the rotation of the wheel 104 when going down a slope is used immediately to brake the motor. These embodiments allow the user to remain in control of the device 20, 60, 70 and/or 80.

When an upslope event is detected, the motor 105 provides increased torque to reduce the efforts provided by the user. For example, the cyclic ratio applied to the terminals of the motor 105 can be increased automatically so that the torque is greater.

In the embodiments shown in FIGS. 2 and 6, representing an inline skate 20 or roller skate 60, the means for measuring an angular change is configured to measure a value of a physical quantity representative of an inclination. The inclination occurs, for example, in the plane comprising the axis of movement 100 and the vertical axis 102.

The inline skate 20 or roller skate 60 also comprises a means 15 for detecting a braking event, representative of braking by the user, comprising a means 16 for calculating at least one angular difference and a means 16 for comparing the angular difference with a predefined angular limit value, the braking event being detected when the angular change is greater than the predefined angular limit value.

When a braking event is detected, a drive speed of the motor is reduced, and the wheel 104 is therefore slowed down.

Preferably, two inline skates 20 or roller skates 60 are combined into a pair for the user's two feet. In some embodiments, depending on the device of the pair that detects the angular change, a mechanical or electric braking can be detected.

In some embodiments, the calculation means is configured to calculate:
an angular difference between the inclination of one of the two inline skates 20 or roller skates 60 and the inclination of the other inline skate 20 or roller skate 60 of the pair; and/or
an angular difference between an inclination at one instant and an inclination at a later instant, for example 500 ms later.

In some embodiments (not shown), each inline skate 20 or roller skate 60 comprises a pressure sensor, a means for comparing the pressure captured with a predefined pressure limit, a braking event being detected when the pressure captured is less than the predefined pressure limit for just one of the inline skates 20 or roller skates 60 of the pair, and when the voltage measured on each inline skate 20 or roller skate 60 of the pair is substantially equal. This is because the pressure is altered by lifting part of the foot to exert or simulate mechanical braking. Based on the lifting of the foot, mechanical or electrical braking is exerted.

Thus, the user has the choice between mechanical braking and electrical braking. Mechanical braking is, for example, a plastic pad, made of silicon or rubber, known to the person skilled in the art, which brakes by friction against the ground. For an inline skate 20, the mechanical brake is usually placed at the rear of the inline skate 20. For a roller skate 60, the mechanical brake is usually placed at the front of the roller skate 60.

For example:
to actuate the mechanical brake, it is just necessary to lift the front of the inline skate 20 positioned on the right foot and the pad, normally raised, thus rubs against the ground;
to actuate the electrical brake, the user lifts the front of the inline skate 20 positioned on the left foot, and the motor brake is therefore actuated by exerting a motor torque in the reverse of rotation of the movement; and
when an angular change with substantially the same values is detected on both inline skates 20 of the pair, the user is considered to be going up a slope.

The different modes of operation of the motor 105 are illustrated in FIG. 5. FIG. 5 shows the curve 50 representative of the speed of a device 20, 60, 70 and/or 80, as a function of time. The curve 50 is shown in a coordinate space where the X-axis 51 represents the time, and the Y-axis 52 represents the value of the speed.

Vertical dashed lines, 53 to 57, represent detected events. The labels show a mode of operation of the motor as a function of the event detected.

In chronological order, the events are:
detecting a foot propulsion, 53;
putting the motor into operation during the pulse duration ending with the event, 54;
determining a downslope movement, 55;
detecting a braking event, 56; and
detecting a fall 57.

During the period between events 53 and 54, the motor 105 is activated and assists the user. Then, the pulse duration having expired, the motor 105 is in freewheeling mode. The gyroscope detects that the device, 20, 60, 70, and/or 80, is going down a slope, 55, and the motor 105 operates in generator mode. The user brakes, 56, and the speed is therefore reduced. Lastly, a fall, 57, by the user is detected, and the motor is therefore inhibited and operates in freewheeling mode.

In some embodiments (not shown), the module comprises a switch for activating or deactivating the module.

In some embodiments (not shown), the module comprises a wireless communication means, such as the Bluetooth (registered trademark) standard or the IEEE 802.11-standard, aka “Wi-Fi”. The means for implementing this technology is, for example, an antenna connected to a microprocessor configured to control the operation of the antenna.

FIG. 9 shows a pair of inline skates, 20-1 and 20-2, and/or 400-1 and 400-2, the subjects of the present invention. Each inline skate, 20-1, 20-2, 400-1 and/or 400-2, is equipped with a wireless communication means.

The speed of the motors on the inline skates, 20-1 and 20-2, and/or 400-1 and 400-2, does not need to be synchronised. Three examples can be identified of scenarios in which the inline skates, 20-1 and 20-2, and/or 400-1 and 400-2, communicate:
when going down a slope, to check that the same negative angle is detected on both inline skates, or when the voltage 201 is greater than the predefined voltage limit 202 on both inline skates, 20-1 and 20-2, and/or 400-1 and 400-2;
when braking, to check whether this is a case of mechanical or electrical braking;
for communicating the statistics, such as the distance travelled, the autonomy of each inline skate, 20-1 and 20-2, and/or 400-1 and 400-2, to a communicating portable terminal 91. The information collected on one of the inline skates, 20-1 and/or 400-1, is transmitted to the other inline skate, 20-2, and/or 400-2, which collates it with the information collected and communicates the collated information to the communicating portable terminal 91.

In some embodiments, each device, 20, 60, 70 and/or 80, can comprise a means for communicating with a communicating portable terminal 91.

The communicating portable terminal 91 can be a smartphone, a digital tablet or a connected watch, for example.

In some embodiments, the communicating portable terminal 91 can comprise a means for controlling the module. For example, the communicating portable terminal 91 can comprise the following controls:
controlling the cyclic ratio of the voltage applied to the terminals of the motor 105, for modifying the torque applied and therefore the propulsion force;
controlling each predefined limit value, for modifying the sensitivity of the device to detect an event of propulsion, braking, falling, going down a slope or up a slope; and/or
controlling the pulse duration, so that the user supplies more or less effort.

In some embodiments, for each predefined limit value, the cyclic ratio of the voltage applied to the terminals of the motor 105 and the pulse duration are adjusted as a function of the data received corresponding to situations by machine learning.

FIG. 11 shows a series of steps of a particular embodiment of a method 300 of electric assistance for a wheeled sliding device 20, 60, 70 and/or 80, comprising at least two wheels 104, 21 and/or 22, which method comprises:
a step 301 of measuring a voltage of at least one phase of a 3-phase electric motor representative of a movement of the wheeled device;
a step 302 of motorisation configured to drive in rotation at least one said wheel during a predefined period of time referred to as “pulse duration” after a foot propulsion event is detected; and
a step 304 of detecting a propulsion event, as a function of a voltage value of at least one phase of the 3-phase electric motor and at least one predefined voltage limit, this event corresponding to a foot propulsion of the device by a user.

Preferably, the means of the devices, 20, 60, 70, and/or 80, are configured to implement the steps of the method 300 and their embodiments as described above, and the method 300 and its different embodiments can be implemented by the means of the devices, 20, 60, 70, and/or 80.

Preferably, the steps of the method 300 are performed by a computer program comprising a set of instructions executed by a microprocessor.

1. Module for a wheeled sliding device with electric assistance comprising at least two wheels, the module comprising:
a means for measuring a voltage of at least one phase of a three-phase electric motor representative of a movement of the wheeled device;
the 3-phase electric motor configured to drive in rotation at least one said wheel during a predefined period of time referred to as “pulse duration” after a foot propulsion event has been detected; and
a means for detecting a propulsion event, as a function of a voltage value of at least one phase of the 3-phase electric motor and at least one predefined voltage limit, this event corresponding to a foot propulsion of the device by a user.

2. Module according to claim 1, wherein the detection means compares each back electromotive force between each phase of the motor and the ground to at least one predefined voltage limit.

3. Module according to claim 1, the detection means also comprises a means for detecting a pace of the user according to the result of a comparison between a voltage value of at least one phase of the 3-phase motor and several predefined voltage limits, each predefined voltage limit being representative of a pace of the user.

4. Module according to claim 3, wherein the detection means also comprises a means for controlling a cyclic ratio of an electric signal supplying the 3-phase electric motor with electrical energy as a function of the pace determined.

5. Module according to claim 3, which comprises a means for controlling a pulse duration as a function of the pace determined.

6. Module according to claim 1, wherein the detection means is configured to detect a braking event as a function of a value of the derivative of the voltage of at least one phase of the 3-phase motor and of at least one predefined negative limit value, called the “predefined derivative limit”.

7. Module according to claim 6, which comprises a means for activating a motor brake when the value of the derivative of the voltage of at least one phase of the 3-phase motor is less than a predefined derivative limit.

8. Module according to claim 1, which comprises:
a second means for measuring a value of a physical quantity representative of a movement, comprising a means for measuring an angular change configured to measure a value of a physical quantity representative of an inclination of the device, and wherein
the detection means comprises a determination means for identifying an increase or decrease in the inclination measured; and
this device comprises a means for inhibiting the motor as a function of the value of inclination measured.

9. Module according to claim 8, wherein the device is an inline skate or roller skate, which also comprises:
a means for calculating at least one angular difference;
a means for detecting a braking event, representative of braking by the user, comprising a means for comparing the angular difference with a predefined angular limit value, the braking event being detected when the angular change is greater than the predefined angular limit value.

10. Module according to claim 9, wherein a drive speed of the motor is reduced when a braking event is detected.

11. Module according to claim 1, wherein the pulse duration is less than two seconds and preferably less than one second.

12. Electrically assisted wheeled sliding device, comprising at least two wheels, device comprising a module according to claim 1.

13. Pair of devices, each device being according to claim 12, wherein each device is an inline skate or a roller skate and a propulsion event being detected when the voltage measured is greater than the predefined voltage limit on a single one of the pair of devices.

14. Pair of devices according to claim 13, wherein each device comprises a means for communicating with the other device, configured to communicate the voltage measured by the device comprising the communication means and/or when the voltage measured by the device comprising the communication means is greater than the predefined voltage limit.

15. Pair of devices according to claim 13, wherein at least one detection means of a device is configured to detect a downslope or freewheel event as a function, for each device of the pair, of:
a voltage value of at least one phase of the 3-phase electric motor and at least one predefined voltage limit; and
a sign of the derivative of the voltage of this phase of the 3-phase motor.

16. Pair of devices each device comprising a module according to claim 6, wherein the detection means is configured to detect a freewheel event when the value of the derivative of the voltage of this phase is less than the “predefined derivative limit”.

17. Method of electric assistance for a wheeled sliding device comprising at least two wheels, characterized in that it comprises:
a step of measuring a voltage of at least one phase of a three-phase electric motor representative of a movement of the wheeled device;
a step of motorization configured to drive in rotation at least one said wheel during a predefined period of time referred to as “pulse duration” after a foot propulsion event is detected; and
a step of detecting a propulsion event, as a function of a voltage value of at least one phase of the 3-phase electric motor and at least one predefined voltage limit, this event corresponding to a foot propulsion of the device by a user.
